(19) United States
(12) Patent Application Publication
(10) Pub. No.: US 2015/0099877 A1
(43) Pub. Date: Apr. 9, 2015

(54) ELECTRODE ACTIVE MATERIAL CONTAINING HETEROCYCLIC COMPOUND FOR LITHIUM SECONDARY BATTERY, AND LITHIUM SECONDARY BATTERY CONTAINING THE SAME

(71) Applicant: AGENCY FOR DEFENSE DEVELOPMENT, Daejeon (KR)

(72) Inventors: Sanghyeon HA, Daejeon (KR); Dongik CHEONG, Sejong (KR); Chanbeum PARK, Daejeon (KR); Minah LEE, Daejeon (KR); Jihyun HONG, Busan (KR); Kisuk KANG, Gwacheon-si (KR)

(73) Assignee: AGENCY FOR DEFENSE DEVELOPMENT, Daejeon (KR)

(21) Appl. No.: 14/147,671

(22) Filed: Jan. 6, 2014

(30) Foreign Application Priority Data
Oct. 4, 2013 (KR) 10-2013-0118435

(51) Int. Cl. H01M 4/60; H01M 10/052

(52) U.S. Cl. CPC H01M 4/60; H01M 10/052
USPC 544/251

(57) ABSTRACT

An electrode active material for a lithium secondary battery using a heterocyclic compound and a lithium secondary battery including the same are provided. The heterocyclic compound, which is useful as a cathode or anode active material, includes a six-membered ring and a five-membered ring containing one or more elements selected from the group consisting of nitrogen (N), oxygen (O) and sulfur (S), and the heterocyclic compound is configured such that two pairs of carbons which form double bonds with nitrogen atoms contain a functional group linked by a single bond, thus exhibiting redox activity.

### CROSS REFERENCE TO RELATED APPLICATION

This application claims the benefit of Korean Patent Application No. KR 10-2013-0118435, filed Oct. 4, 2013, which is hereby incorporated by reference in its entirety into this application.

### BACKGROUND OF THE INVENTION

1. Technical Field

The present invention relates to an electrode active material for a lithium secondary battery using a heterocyclic compound and to a lithium secondary battery including the same. More particularly, the present invention relates to an electrode active material for a lithium secondary battery, wherein a heterocyclic compound, including a six-membered ring and a five-membered ring containing one or more elements selected from the group consisting of nitrogen (N), oxygen (O) and sulfur (S), is used as a cathode or anode active material, and the heterocyclic compound is configured such that two pairs of carbons which form double bonds with nitrogen atoms contain a functional group linked by a single bond, thus exhibiting redox activity, and to a lithium secondary battery including the same.

2. Description of the Related Art

As for cathode materials for high-capacity and high-power lithium secondary batteries, metal oxides based on transition metals (cobalt, manganese, nickel iron, etc.) have been typically utilized, but are problematic because limitations are imposed on increasing the capacity of batteries and environmental pollution may occur in battery fabrication processes and recycling processes. Hence, many attempts are being made to utilize organic materials obtainable from nature as electrode materials in order to develop energy storage materials which may be continuously used and are eco-friendly. However, as conventional biomimetic cathode or anode active materials, only organic compounds based on oxidation and reduction of a carbonyl group have been limitedly studied, and performance thereof is still insufficient to replace conventional cathode materials.

Meanwhile, tremendous kinds of redox active materials are present in natural organisms, and there is a need for research into accurately understanding and mimicking the structures and functions of such materials to develop high-performance energy storage materials.

### CITATION LIST

### Patent Literature

Korean Patent Application Publication No. 10-2012-0090113

Korean Patent Application Publication No. 10-2013-0003865

### SUMMARY OF THE INVENTION

Accordingly, the present invention has been made keeping in mind the above problems encountered in the related art, and an object of the present invention is to provide an electrode active material for a lithium secondary battery, which includes a heterocyclic compound, preferably a biomimetic heterocyclic compound, and a lithium secondary battery including the same, wherein the lithium secondary battery may be continuously used, is eco-friendly and may have improved energy density.

In order to accomplish the above object, the present invention provides an electrode active material for a lithium secondary battery, including a heterocyclic compound.

In addition, the present invention provides a lithium secondary battery, including the electrode active material as above.

### BRIEF DESCRIPTION Of THE DRAWINGS

The above and other objects, features and advantages of the present invention will be more clearly understood from the following detailed description taken in conjunction with the accompanying drawings, in which:

FIG. 1 is a reaction scheme illustrating the redox principle of a lithium secondary battery using, as a cathode or anode active material, a heterocyclic compound which mimics a redox material in vivo, in comparison with the redox principle in nature;

FIGS. 2A and 2B are graphs illustrating the results of evaluation of the electrochemical properties of a lithium secondary battery manufactured using, as a cathode, riboflavin according to an embodiment of the present invention; and

FIG. 3A illustrates the chemical formulas of organic materials synthesized by substituting an isoalloxazine heterocyclic compound according to an embodiment of the present invention with functional groups different in mass and negative electricity, and FIGS. 3B and 3C are graphs illustrating the results of evaluation of the electrochemical properties of lithium secondary batteries manufactured using such materials as cathodes.

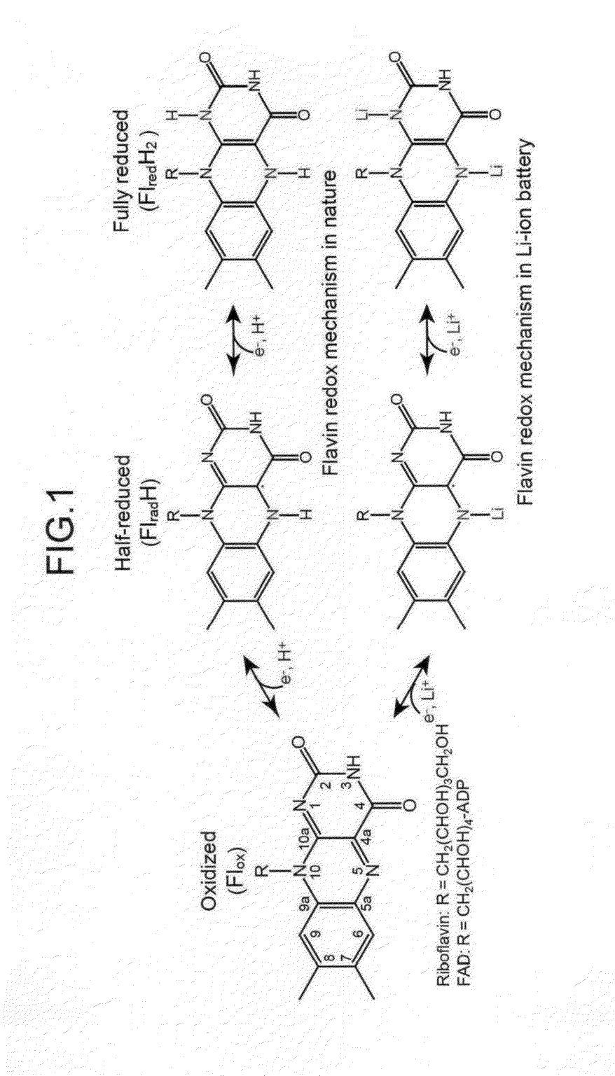

### DESCRIPTION OF THE PREFERRED EMBODIMENTS

Hereinafter, a detailed description will be given of the present invention.

The present inventors have discovered that the energy metabolism of cells that make up organisms is similar to a principle of operation of lithium secondary batteries. More particularly, the present inventors have ascertained that flavin adenine dinucleotide (FAD) molecules in mitochondria act to transfer energy through hydrogen and electron transport during cellular respiration, and energy may be stored even in lithium secondary batteries using the action thereof and have developed an electrode active material for a lithium secondary battery using a biomimetic heterocyclic compound which mimics the cellular respiratory function in vivo as a next-generation electrode material for a lithium secondary battery, by applying biomaterials involved in the redox reactions during metabolism to electrode materials of lithium secondary batteries, and also a lithium secondary battery including such an electrode active material, thus culminating in the present invention.

The present invention is directed to an electrode active material for a lithium secondary battery, including a heterocyclic compound. As such, the electrode active material indicates a cathode or anode active material.

According to the present invention, the heterocyclic compound is preferably a biomimetic heterocyclic compound. More specifically, the heterocyclic compound may include one or more of six-membered and five-membered rings containing one or more elements selected from the group consisting of nitrogen (N), oxygen (O) and sulfur (S).

Also, the cyclic compound may be a polycyclic compound including two or more six-membered rings.

The heterocyclic compound may be substituted with one or more substituents selected from the group consisting of an alkyl group, an alkoxyl group, a hydroxyl group, a carbonyl group, a cyane group, an amine group, a halogen atom and a halogenated alkyl, and the heterocyclic compound may react with one or more lithium ions to reversibly form a lithium-containing compound.

Also, the heterocyclic compound may include one or more selected from the group consisting of purine, xanthine, adenine, quinine and uric acid.

Also, the six-membered ring is a diazine ring containing two nitrogen atoms, and the diazine ring may include one or more selected from the group consisting of pyrazine, pyrimidine and pyridazine.

Also, the polycyclic compound may include one or more selected from the group consisting of a pteridine group, an alloxazine group, an isoalloxazine group and a quiuoxaline group.

In addition, the present invention is directed to a lithium secondary battery, including the electrode active material as set forth.

As described hereinbefore, the present invention provides an electrode active material containing a heterocyclic compound for a lithium secondary battery and a lithium secondary battery including the same. According to the present invention, the electrode active material for a lithium secondary battery using the heterocyclic compound is preferably based on redox active materials in natural organisms and thus can be continuously used and is eco-friendly, and the capacity and voltage of the electrode material can be effectively changed and adjusted depending on the chemical modification treatment of organic molecules which are biomaterials, making it possible to ensure improved energy density of a lithium secondary battery including an organic electrode material in future.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### EXAMPLE 1

### Electrochemical Measurements

Electrochemical performances of flavin molecules were measured versus a Li metal foil (Hohsen Corp., Japan) in coin-type cells (CR2016). The electrodes were fabricated by mixing 50% w/w active materials, 30% w/w carbon black (Super P) and 20% w/w PTFE (polytetrafluoroethylene, Aldrich) binder. A porous polypropylene membrane (Celgard 2400) was used as a separator. The electrolyte was 1M LiPF₆ in ethylene carbonate (EC)/dimethyl carbonate (DMC) (1:1 v/v, Techno Semichem Co., Ltd., Korea). The cells were assembled in an inert atmosphere within an Ar-filled glove box. The discharge and charge measurements were carried out at a constant current density of 10 mAg⁻¹ in voltage ranges of 1.5˜3.8 V on a battery test system (Won-A Tech, Korea), for GITT measurement the Li/flavin cells were discharged and charged for 1 h at 5 mAg⁻¹ with 2 h rest time, in galvanostatic mode.

### EXAMPLE 2

### Confirmation of the Material Stability

To confirm structural consistency, X-ray diffraction (XRD) patterns of riboflavin powder and the as-prepared riboflavin electrode were collected on a Bruker D2phaser (Germany) using Cu Kα radiation (λ=1.54178 Å) with a scanning speed of 1° per minute in the range 2θ_{CuKα}=5−40° with a 2θ step size of 0.02°. The photochemical stability of the riboflavin electrode with electrolyte EC/DMC was confirmed by Fourier transform infrared spectroscopy (FTIR) and UV/Vis absorbance spectroscopy. The riboflavin powder, as-prepared electrodes, and as-prepared electrodes stored in EC/DMC for 24 h were compared. The electrode retrieved by disassembling as-prepared coin cells preserved for 24 h and rinsed with DMC was used as the sample stored in electrolyte. FTIR spectra of pellets made of riboflavin powder (or electrodes) and KBr powder were recorded on a FT/IR-4200 (Jasco Inc., Japan) at a resolution of 2 cm⁻¹ in argon atmosphere. For UV/Vis absorbance spectroscopy, each sample was immersed in degassed, deionized water in argon atmosphere, resulting in immediate solubilization of the riboflavin molecules. UV/Vis absorbance spectra were obtained using a V/650 spectrophotometer (Jasco Inc., Japan) in the range of 200-600 nm.

### EXAMPLE 3

### Ex Situ Electrode Characterization

For ex situ analyses, the electrodes at the different states of charge (as-prepared, fully discharged to 1.5 V, and fully recharged to 3.8 V) were disassembled from coin cells and rinsed with DMC. To prevent exposure to air, all the samples were handled in an Ar-filled glove box. X-ray photoelectron spectroscopy (XPS) measurements were performed by using a Thermo VG Scientific Sigma Probe spectrometer (U.K.) equipped with a microfocus monochromated X-ray source (90 W). All the binding energies are referenced to C 1 s (284.5 eV). FTIR and absorbance spectra were collected by following the method described previously in stability confirmation. Li magic-angle spinning (MAS) nuclear magnetic resonance (NMR) analysis was performed for the riboflavin electrode after fully discharged to 1.5 V. The NMR spectrum was obtained using a solid-state 400 MHz NMR spectrometer (AVANCE 400WB, Broker Science, Germany) at room temperature.

### EXAMPLE 4

### Computational Details

All energy calculations were conducted with spin-unrestricted density functional theory (DFT) using the Gaussian 09 quantum chemistry package. Geometry optimizations were carried out with Becke-Lee-Yang-Parr (B3LYP) hybrid exchange-correlation functional and the standard TZVP basis set. To determine the sites and sequence of lithium occupation upon redox reactions, DFT energies of various possible forms of Fl_{rad}Li and Fl_{red}Li₂ were compared. Mulliken population analysis was used to analyze atomic charge.

### TEST EXAMPLE

### The Evaluation of the Properties of a Lithium Secondary Battery

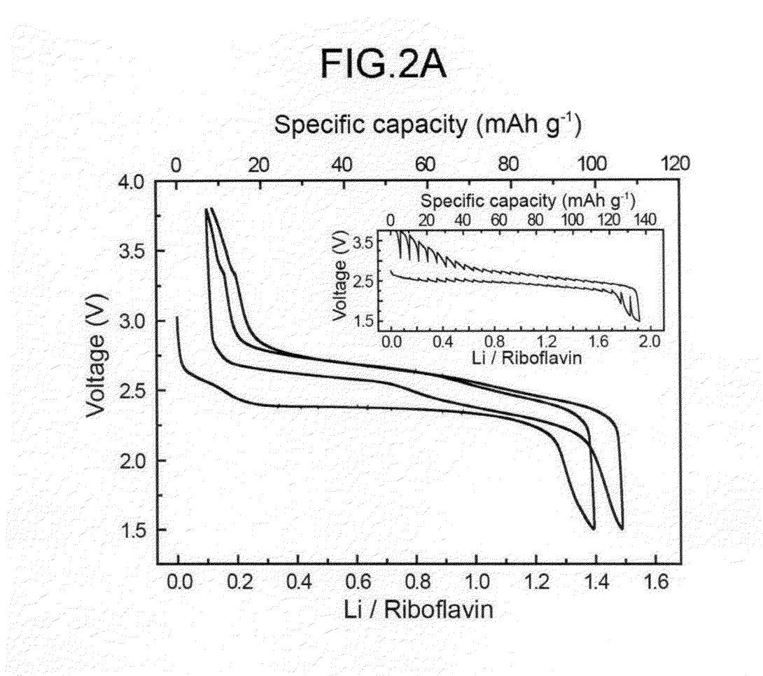

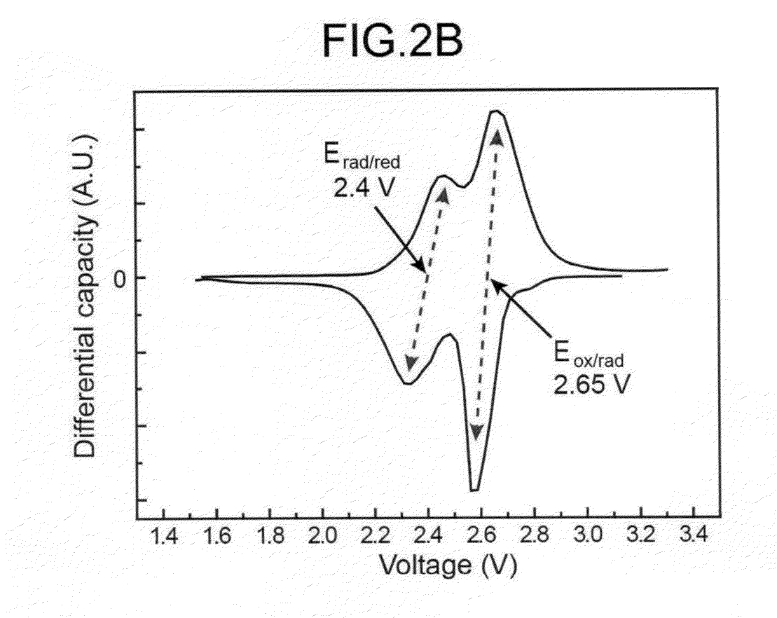

FIGS. 2A and 2B are graphs illustrating the results of evaluation of the electrochemical properties of a lithium secondary battery manufactured using, as a cathode, riboflavin. Discharge/charge profiles of a Li/riboflavin cell and GITT profiles (inset) are illustrated in FIG. 2A. According to the galvanostatic measurements, riboflavin/Li cells exhibited a reversible capacity of approximately 105.89 mAhg⁻¹, equivalent to 1.49 Li atoms per unit formula between 1.5 and 3.8 V at a current rate of 10 mAg⁻¹. The theoretical capacity of two lithium ions in the riboflavin electrode is 142.43 mAg⁻¹. The present inventors also conducted galvanostatic intermittent titration technique (GITT) measurements with the riboflavin electrode under a low current density, which allowed sufficient time for full lithium access to riboflavin. Based on the GITT result, which manifests a much higher reversible capacity (1.90 Li atoms per riboflavin molecule), it is demonstrated that the flavin electrode is capable of accepting and releasing two lithium ions per formula unit. The energy storage reaction of the riboflavin electrode was found to follow two consecutive one-electron transfer reactions. The differential capacity curves contain two sets of distinctive cathodic and anodic peaks with average potentials of 2.65 and 2.4 V, respectively (FIG. 2B). This indicates that the lithium-coupled electron-transfer reaction of the riboflavin electrode occurs in two different environments and evidences a relative stability of the intermediate phase, resulting in two consecutive one-electron reduction steps.

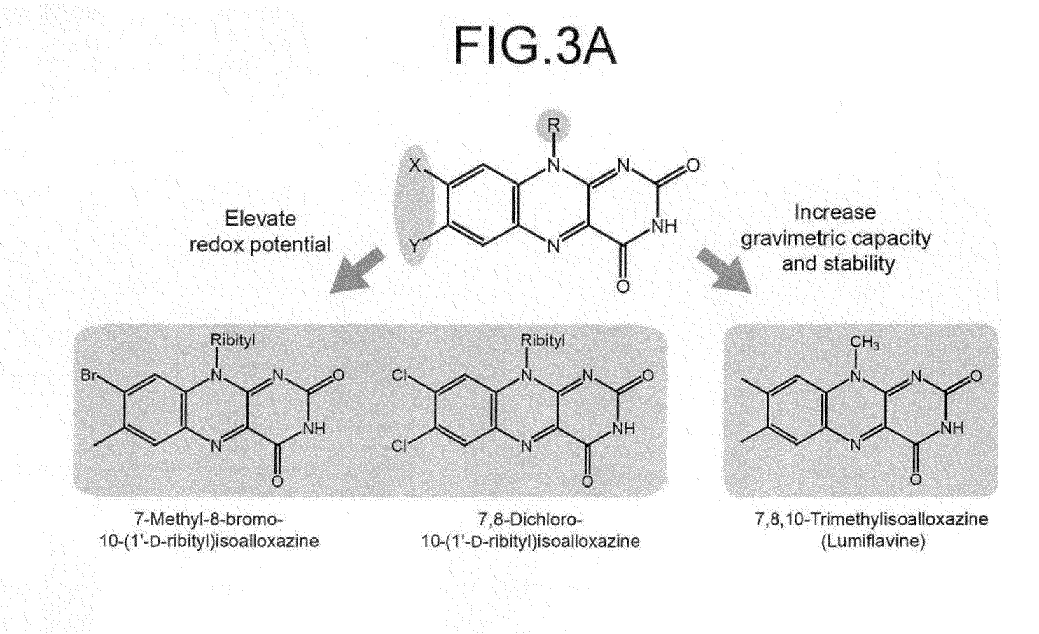

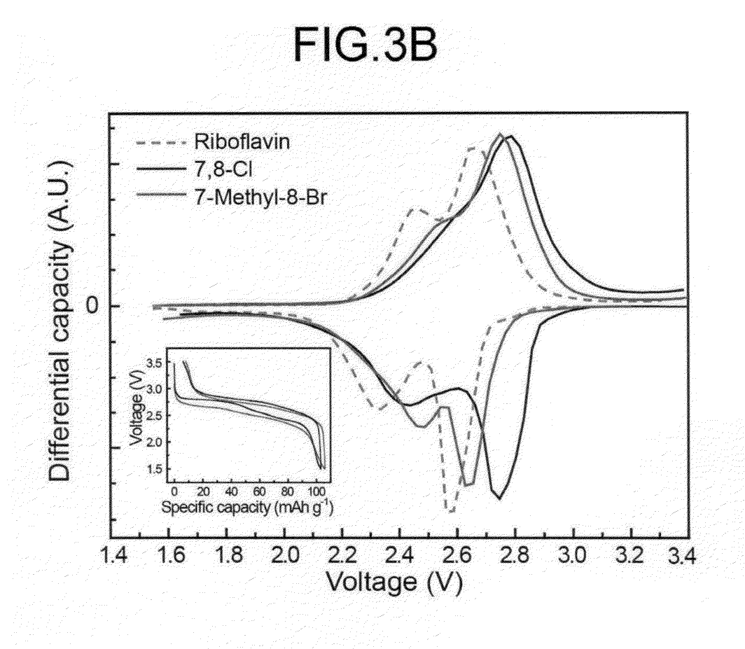

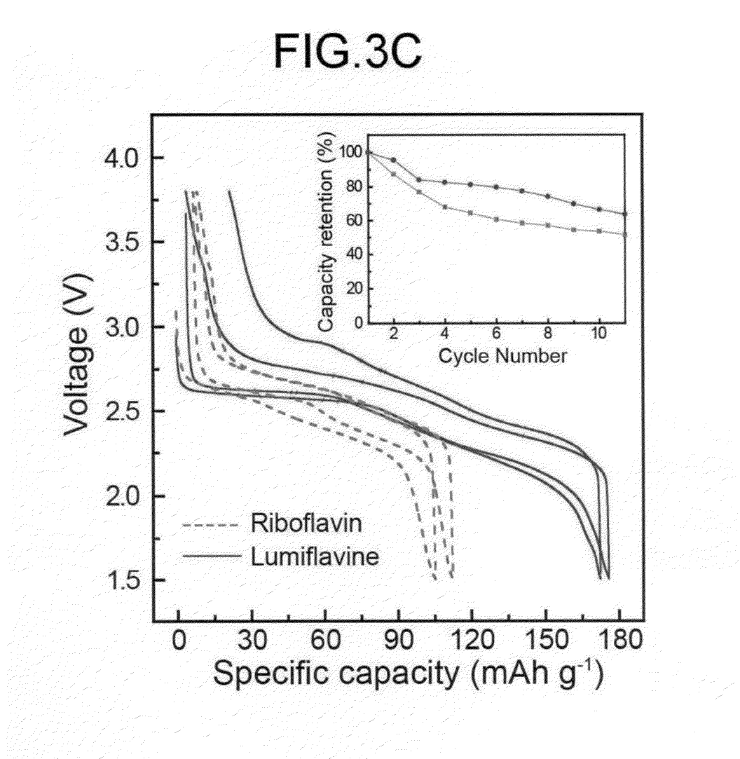

Also, FIG. 3A illustrates the chemical formulas of organic materials synthesized by substituting an isoalloxazine heterocyclic compound with functional groups different in mass and negative electricity, and FIGS. 3B and 3C are graphs illustrating the results of evaluation of the electrochemical properties of lithium secondary batteries manufactured using such materials as cathodes. FIG. 3B illustrates differential capacity (dQ/dV) curves of Li/7-methyl-8-bromo-10-(1′-d-ribityl)isoalloxazine (gray) and Li/7,8-dichloro-10-(1′-d-ribityl)isoalloxazine (black) cells compared to Li/riboflavin cell (gray, dotted) calculated from the discharge/charge profiles (inset). The replacement of the methyl group by chlorine atoms at C7 and C8 (7, 8-dichloro-10-ribitylisoalloxazine), and bromine atom at C8 (7-methyl-8-bromo-10-ribitylisoalloxazine) raised the operating voltage of flavin electrodes. The changes in the average redox potential for each analog were 0.14 and 0.09 V, respectively. FIG. 3C illustrates discharge/charge profiles of a Li/lumiflavine cell (black) compared to the Li/riboflavin cell (gray, dotted). The capacity retention of the Li/lumiflavine cell compared to the Li/riboflavin cell is shown in the inset, lumiflavine, with a theoretical capacity as high as 209.18 mAhg⁻¹. According to the observation, the gravimetric capacity of lumiflavine was much higher (174.32 mAhg⁻¹) than that of riboflavin (105.88 mAhg⁻¹) with negligible transition in the redox potential in a galvanostatic measurement under the same experimental conditions. In addition, the alternation of the side group from ribityl to nonpolar group reduced dissolution of flavin molecules in polar electrolytes. The lumiflavine electrode exhibited the capacity retention of 66.3% after 10 cycles, which is higher than that of the riboflavin electrode (53.6%; FIG. 3C inset). The present inventors attribute this result to the differential solubility of the molecules.

What is claimed is:

1. An electrode active material for a lithium secondary battery, comprising a heterocyclic compound.

2. The electrode active material of claim 1, wherein the heterocyclic compound comprises one or more of a six-membered ring and a five-membered ring containing one or more elements selected from the group consisting of nitrogen (N), oxygen (O) and sulfur (S).

3. The electrode active material of claim 2, wherein the heterocyclic compound is a polycyclic compound comprising two or more six-membered rings.

4. The electrode active material of claim 1, wherein the heterocyclic compound is substituted with one or more substituents selected from the group consisting of an alkyl group, an alkoxyl group, a hydroxyl group, a carbonyl group, a cyane group, an amine group, a halogen atom and a halogenated alkyl.

5. The electrode active material of claim 2, wherein the heterocyclic compound is substituted with one or more substituents selected from the group consisting of an alkyl group, an alkoxyl group, a hydroxyl group, a carbonyl group, a cyane group, an amine group, a halogen atom and a halogenated alkyl.

6. The electrode active material of claim 3, wherein the heterocyclic compound is substituted with one or more substituents selected from the group consisting of an alkyl group, an alkoxyl group, a hydroxyl group, a carbonyl group, a cyane group, an amine group, a halogen atom and a halogenated alkyl.

7. The electrode active material of claim 1, wherein the heterocyclic compound reacts with one or more lithium ions to reversibly form a lithium-containing compound.

8. The electrode active material of claim 2, wherein the six-membered ring is a diazine ring containing two nitrogen atoms.

9. The electrode active material of claim 8, wherein the diazine ring is one or more selected from the group consisting of pyrazine, pyrimidine and pyridazine.

10. The electrode active material of claim 3, wherein the polycyclic compound comprises one or more selected from the group consisting of a pteridine group, an alloxazine group, an isoalloxazine group and a quinoxaline group.

11. The electrode active material of claim 2, wherein the heterocyclic compound is one or more selected from the group consisting of purine, xanthine, adenine, quinine and uric acid.

12. The electrode active material of claim 1, wherein the heterocyclic compound is a biomimetic heterocyclic compound.

13. A lithium secondary battery, comprising the electrode active material of claim 1.

14. A lithium secondary battery, comprising the electrode active material of claim 2.

15. A lithium secondary battery, comprising the electrode active material of claim 3.

16. A lithium secondary battery, comprising the electrode active material of claim 4.

17. A lithium secondary battery, comprising the electrode active material of claim 5.

18. A lithium secondary battery, comprising the electrode active material of claim 6.

19. A lithium secondary battery, comprising the electrode active material of claim 7.

20. A lithium secondary battery, comprising the electrode active material of claim 8.

21. A lithium secondary battery, comprising the electrode active material of claim 9.

22. A lithium secondary battery, comprising the electrode active material of claim 10.

23. A lithium secondary battery, comprising the electrode active material of claim 11.

24. A lithium secondary battery, comprising the electrode active material of claim 12.
